(19) United States
(12) Patent Application Publication
(10) Pub. No.: US 2016/0352426 A1
(43) Pub. Date: Dec. 1, 2016

(54) PULSED LASER COMMUNICATION

(71) Applicant: Asa A. Bowers, Cupertino, CA (US)

(72) Inventor: Asa A. Bowers, Cupertino, CA (US)

(21) Appl. No.: 14/724,371

(22) Filed: May 28, 2015

(51) Int. Cl. H04B 10/118

(52) U.S. Cl. CPC H04B 10/118

(57) ABSTRACT

To attempt communication with extraterrestrial intelligent life, information is encoded in a pulsed laser beam. The pulsed laser beam is directed to a selected extra-terrestrial location.

### BACKGROUND

The search for extraterrestrial intelligence (SETI) has been carried out using various methodologies. For example, electromagnetic radiation from space is analyzed to determine whether any patterns indicate intelligent origin. So far, there has been no documented success in detecting intelligent extraterrestrial life.

### BRIEF DESCRIPTION OF THE DRAWINGS

FIG. 1 shows a laser and control system configured to provide laser light pulses into space indicating the existence of intelligent life on earth accordance with an implementation.

FIG. 2 shows a satellite being used to relay light pulses into space in accordance with an implementation.

### DESCRIPTION OF THE EMBODIMENT

In accordance with various implementations, communication with extraterrestrial intelligent life is attempted by encoding information in a pulsed laser beam. The pulsed laser beam is directed to a selected extra-terrestrial location.

For example, encoding the information in the pulsed laser beam includes encoding using a binary code, a ternary code, a quaternary code or another code.

For example pulses with a pulse duration of at least one second are used. In one example of this, for a binary code, a pulse duration that is approximately three seconds is used to represent a binary “1” a pulse duration that is approximately one second is used to represent a binary “0”.

For example, the pulsed laser beam is directed from earth to the selected extra-terrestrial location. Alternatively, the pulsed laser beam is directed from a satellite to the selected extra-terrestrial location. Alternatively, the pulsed laser beam is directed from earth and related or reflected to the selected extra-terrestrial location by a satellite.

For example, the information encoded in the pulsed laser beam is a pattern based on composition of chemical elements such as Hydrogen, Oxygen, Carbon, Nitrogen, Phosphorus, Sulfur, Calcium, Chlorine, Sodium, Magnesium and Potassium or is a pattern based on celestial coordinates of the earth.

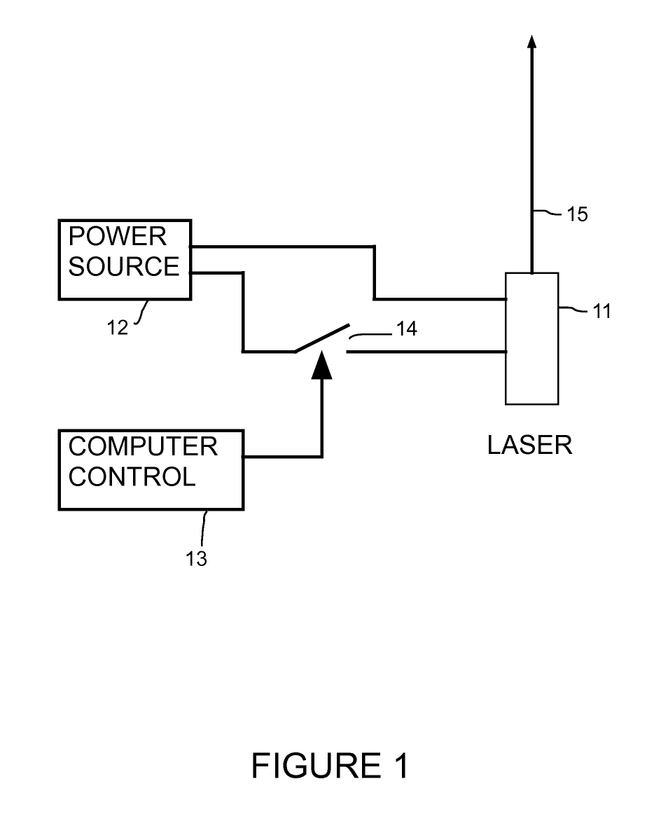

More specifically, FIG. 1 shows a laser 11 driven by a power source 12. A compute control 13 controls a switch 14 that turns laser 11 on and off to produce a pulsed laser beam 15. For example, laser 11 is a multiple watt laser of sufficient power to reach and travel long distances in space.

For example, laser 11 uses a long pulse of laser light that is approximately three seconds to represent a binary “1” and a short pulse that is approximately one second to represent a binary “0”. This is only exemplary as other durations of pulses can be used to represent a binary “1” and a binary “0”. Alternatively, different numbers of pulse lengths can be used for differing number systems. For example, three different pulse lengths can be used in a ternary system. For example, four pulse lengths can be used in a quaternary system. And so on.

Laser 11 can be located at a base station on earth, or can be located in a satellite traveling around the earth. Alternatively, laser 11 can be located in a space station or space ship that has broke free of earth's orbit and is traveling through space. Also, while a single laser 11 is shown in FIG. 1, multiple lasers can be used simultaneously to beam communication to different locations or a same location in space.

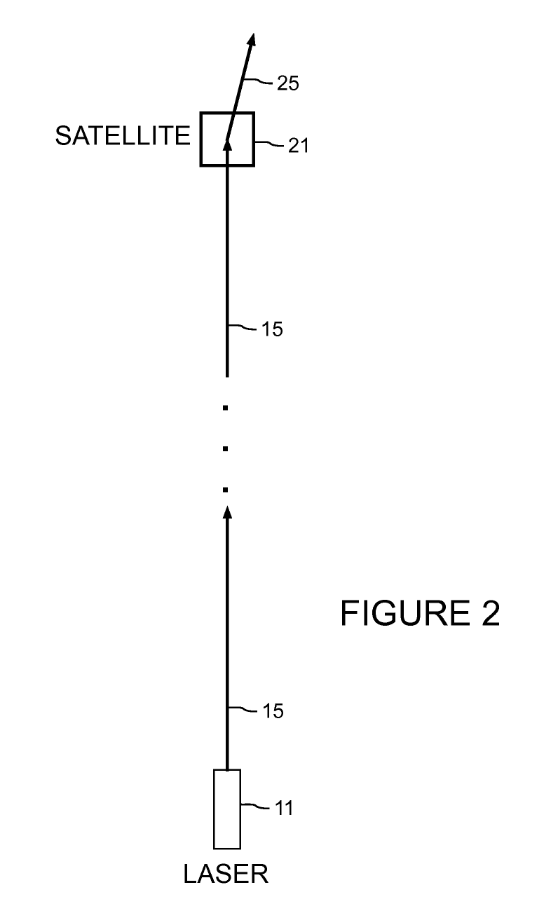

While pulsed laser beam 15 can be sent from earth directly into space, it is also possible to use a satellite to relay the laser beam in a particular direction in space. For example, FIG. 2 shows pulsed laser beam 15 being relayed by a satellite 21. A redirected pulsed laser beam 25 leaves satellite 21 for a destination in space. Pulsed laser beam 15 can be reflected using mirrors, relayed, or otherwise redirected to produce pulsed laser beam 25.

Pulsed laser beam 15 can be directed in whatever direction desired to attempt communication with extraterrestrial life. Prime candidates might be star systems that have planets in an inhabitable zone. Other candidates might be suspected locations of black holes or worm holes. Because of the distances involved and the time for light to reach any selected destinations, precision calculations are required to increase the likelihood that a target destination will be reached by pulsed laser beam 15.

The information encoded by pulsed laser beam 15 can be encoded with patterns that would likely be recognized as having intelligent origins. For example, pulsed laser beam 15 could be binary coded, ternary coded, or quaternary coded with a pattern based on composition of the elements Hydrogen, Oxygen, Carbon, Nitrogen, Phosphorus, Sulfur, Calcium, Chlorine, Sodium, Magnesium, Potassium, and so on. In addition, or alternatively, pulsed laser beam 15 could be binary coded, ternary coded, or quaternary coded with a pattern based on celestial coordinates of the earth.

The use of pulsed laser beams for transmission into space may, to an extraterrestrial, be more quickly recognizable as intelligently originated information than would say laser beams with dense information transfer such as those used for communication in the Optical Payload for Lasercomm Science (OPALS) project by NASA's Jet Propulsion Laboratory in Pasadena, Calif.

While optimized for communication with extraterrestrial life, the lack of information density in pulsed laser beam 15 may make for a less than optimal information transfer rate for communication in applications other than the search for extraterrestrial life. Nevertheless, if one can tolerate the relative slow rate of information transfer, pulsed lasers can be used for point-to-point communications, for example between locations on earth, between locations in space, or between a location on earth and a location in space.

Pulsed laser beam such as laser beam 11 shown in FIG. 2, can also be used in the calibration process to establish connection between a sending a receiving node. Once a pulsed laser beam has been used to lock a laser to its target, an information rich encoded laser beam can be used to transmit data.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A method for attempting communication with extraterrestrial intelligent life, comprising:
encoding information in a pulsed laser beam, wherein encoding the information in the pulsed laser beam includes utilizing pulses with a pulse duration of at least one second; and,
directing the pulsed laser beam to a selected extra-terrestrial location.

2. A method as in claim 1 wherein encoding the information in the pulsed laser beam includes:
encoding using a binary code.

3. A method as in claim 1 wherein encoding the information in the pulsed laser beam includes:
encoding using a ternary code or a quaternary code.

4. (canceled)

5. A method as in claim 1 wherein encoding the information in the pulsed laser beam includes:
using a pulse duration that is approximately three seconds to represent a binary “1”; and
using a pulse duration that is approximately one second to represent a binary “0”.

6. A method as in claim 1, wherein the pulsed laser beam is directed from earth to the selected extra-terrestrial location.

7. A method as in claim 1, wherein the pulsed laser beam is directed from a satellite to the selected extra-terrestrial location.

8. A method as in claim 1, wherein the pulsed laser beam is directed from earth and related or reflected to the selected extra-terrestrial location by a satellite.

9. A method as in claim 1 wherein the information encoded in the pulsed laser beam is a pattern based on composition of chemical elements or a pattern based on celestial coordinates of the earth.

10. A method as in claim 1 wherein the information encoded in the pulsed laser beam is a pattern based on composition of elements, including one or more of Hydrogen, Oxygen, Carbon, Nitrogen, Phosphorus, Sulfur, Calcium, Chlorine, Sodium, Magnesium, Potassium.

11. A method for extraterrestrial communication, comprising:
selecting an extra-terrestrial location;
directing a pulsed laser beam to the selected extra-terrestrial location; and,
encoding information in the pulsed laser beam, wherein encoding the information in the pulsed laser beam includes utilizing pulses with a pulse duration of at least one second.

12. A method as in claim 11 wherein encoding the information in the pulsed laser beam includes:
encoding using a binary code.

13. A method as in claim 11 wherein encoding the information in the pulsed laser beam includes:
encoding using a ternary code or a quaternary code.

14. (canceled)

15. A method as in claim 11 wherein encoding the information in the pulsed laser beam includes:
using a pulse duration that is approximately three seconds to represent a binary “1”; and
using a pulse duration that is approximately one second to represent a binary “0”.

16. A method as in claim 11, wherein the pulsed laser beam is directed from earth to the selected extra-terrestrial location.

17. A method as in claim 11, wherein the pulsed laser beam is directed from a satellite to the selected extra-terrestrial location.

18. A method as in claim 11, wherein the pulsed laser beam is directed from earth and related or reflected to the selected extra-terrestrial location by a satellite.

19. A method as in claim 11 wherein the information encoded in the pulsed laser beam is a pattern based on composition of chemical elements or a pattern based on celestial coordinates of the earth.

20. A method as in claim 11 wherein the information encoded in the pulsed laser beam is a pattern based on composition of elements, including one or more of Hydrogen, Oxygen, Carbon, Nitrogen, Phosphorus, Sulfur, Calcium, Chlorine, Sodium, Magnesium, Potassium.
